(19) United States
(12) Patent Application Publication
(10) Pub. No.: US 2003/0029208 A1
(43) Pub. Date: Feb. 13, 2003

(54) Portable electronic device physical security

(76) Inventors: Ralph Merrem, San Francisco, CA (US); Jay S. Derman, Palos Verdes Peninsula, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/930,122

(22) Filed: Aug. 13, 2001

(51) Int. Cl. E05B 69/00

(52) U.S. Cl. 70/58

(57) ABSTRACT

The invention includes an apparatus for attaching to a first wall defining a security aperture. The apparatus includes a housing; a locking flange, extending from the housing, having a first orientation relative to the security aperture for retention into the security aperture and a second orientation relative to the security aperture for removal from the security aperture, the locking flange transformable from the first orientation to the second orientation; and a locking member, coupled to the housing and cooperative with the locking flange, for engaging an edge of the first wall outside of the security aperture and inhibiting transformation of the locking flange from the first orientation to the second orientation.

### BACKGROUND OF THE INVENTION

The present invention relates generally to physical security for portable devices, and more specifically to physical security of portable electronic devices having a hinged member that overlies one or more operational interface elements.

Computer physical security devices are well-known.

Many portable devices such as, for example, laptop computers and other portable electronic devices are manufactured having a portion of a housing wall provided with a specially designed security slot. Specifications for this slot have been promulgated by the assignee of the present invention as a standard. This standard may be found at Kensington's web page at http://www.kensington.com/developers/dev₁₃ 1199.html, and is hereby expressly incorporated by reference for all purposes.

It is well-known to provide physical locking devices designed to interface to this specially designed security slot. An exemplary product is the Kensington MICROSAVER® physical security product, as well as other preferred embodiments embodied in several issued U.S. Pat. Nos., including 5,327,752, issued Jul. 12, 1994—entitled “Computer Equipment Lock”; 5,381,685, issued Jan. 17, 1995—entitled “Computer Physical Security Device”; 6,000,251, issued Dec. 14, 1999—entitled “Computer Physical Security Device”; 5,502,989, issued Apr. 2, 1996—entitled “Computer Physical Security Device”; 5,493,878, issued Feb. 27, 1996—entitled “Computer Physical Security Device”; 6,155,088, issued Dec. 05, 2000—entitled “Computer Physical Security Device”; 6,000,252, issued Dec. 14, 1999—entitled “Computer Physical Security Device”; 6,112,562, issued Aug. 5, 2000 entitled “Computer Physical Security Device”; 6,006,557, issued Dec. 28, 1999—entitled “Computer Physical Security Device”; 6,112,561, issued Sep. 05, 2000—entitled “Security Device for a Portable Computer”; 5,787,739, issued Aug. 4, 1998—entitled “Security Hole Fastening Device”; 6,038,891, issued Mar. 21, 2000—entitled “Security Hole Fastening Device” and patent applications 091426,066, filed Oct. 22, 1999—entitled “Cable Locking Device”; 60/128,988, filed Apr. 12, 1999—entitled “Security Hole Fastening Device”; 09/532,382, filed Mar. 22, 2000—entitled “Slot Adapter” and 09/813,924—entitled “Physical Security Device and Method for Portable Device” for example, all hereby expressly incorporated by reference for all purposes.

These products are effective at deterring unauthorized movement of the portable device to which it is secured by localizing the portable device to a relatively immoveable object. The materials of the lock are designed so that the housing must be damaged in order to separate the lock from the portable device. By this expedient, unauthorized movement of the portable device is inhibited for several reasons. These reasons include a reluctance of a party to be observed damaging the housing as it would be obvious to observers that such party was unauthorized to tamper with the portable device. In addition, successfully separating the lock from the portable device in this fashion creates a damaged housing near the defeated security slot that is difficult, if not impossible, to repair, evidencing unauthorized possession of the portable device.

The products embodied in these incorporated patents serve as effective devices to inhibit the unauthorized movement of a portable electronic device beyond a predetermined distance from an object to which the portable electronic device is localized. Commonly, a flexible cable localizes an attachment mechanism to an object other than the portable electronic device, thereby limiting movement away from the object.

The attachment mechanism has a moveable locking member that engages a security slot defined in a wall of the portable device. The locking member, in an engagement configuration, cooperates with the security slot, the housing and possibly other elements of the attachment mechanism to inhibit reconfiguration of the locking member to a disengagement configuration in which the locking member may be disengaged from the security slot.

These solutions achieve a primary goal of such devices, namely to inhibit the unauthorized movement of the portable electronic device. For portable electronic devices that are secured in public or semi-public areas, simple security against unauthorized movement is not sufficient to inhibit unauthorized use of the device while it is securely localized.

The prior art provides physical security solutions that do inhibit use of a portable electronic device while securing the device to a location. One such solution is a carrying case that completely surrounds the portable device and prevents any access or use of the device. A security device may simultaneously maintain the carrying case (with portable device inside) closed, and localized to an object. While this achieves the simultaneous goals of limiting access to the portable electronic device and inhibiting its movement, this solution is undesireable in situations in which a user desires convenient access to the portable electronic device. One such application is use of a laptop in a library or other public resource room. The user desires to access the laptop to records notes, for example, but inhibit operation and movement of the laptop while the user moves about the library. The user desires to quickly re-access the laptop upon returning to the laptop's location. The carrying case solution is too cumbersome for all users in similar situations.

### SUMMARY OF THE INVENTION

The present invention is an efficient, cost effective and convenient physical security solution to the problem of providing access control to portable electronic devices while preserving anti-movement characteristics.

In a preferred embodiment, the invention includes an apparatus for attaching to a first wall defining a security aperture. The apparatus includes a housing; a locking flange, extending from the housing, having a first orientation relative to the security aperture for retention into the security aperture and a second orientation relative to the security aperture for removal from the security aperture, the locking flange transformable from the first orientation to the second orientation; and a locking member, coupled to the housing and cooperative with the locking flange, for engaging an edge of the first wall outside of the security aperture and inhibiting transformation of the locking flange from the first orientation to the second orientation.

An alternate preferred embodiment includes a method for securing a hinged member of a portable electronic device in a closed position while securing an attachment member to a security aperture defined in a wall of the portable electronic device. The process includes engaging the security aperture with a locking flange in a first orientation relative to the security aperture; positioning a locking member into an engagement position, coupled to the locking flange, proximate to the hinged member in the closed position to inhibit transition of the hinged member to an opened position; transforming the locking flange to a second orientation relative to the security aperture in which the locking member is retained within the security aperture to maintain the locking member proximate to the hinged member in the engagement position and to retain the locking flange in engagement with the security aperture until the locking flange is transformed into an orientation other than the first orientation relative to the security aperture; and operating a lock, coupled to the locking flange, to a lock position while the locking flange is in the second orientation to inhibit transformation of the locking flange to an orientation that permits disengagement of the locking flange from the security aperture and repositioning of the locking member from the engagement position until the lock is operated to an unlock position.

These and other novel aspects of the present invention will be apparent to those of ordinary skill in the art upon review of the drawings and the remaining portions of the specification.

### BRIEF DESCRIPTION OF THE DRAWINGS

FIG. 1 is a perspective view of a locking system according to a preferred embodiment of the present invention;

FIG. 2 is a perspective view of an attachment system according to a preferred embodiment of the present invention; and

FIG. 3 is a perspective view of an alternate attachment system according to an alternate preferred embodiment.

### DESCRIPTION OF THE SPECIFIC EMBODIMENTS

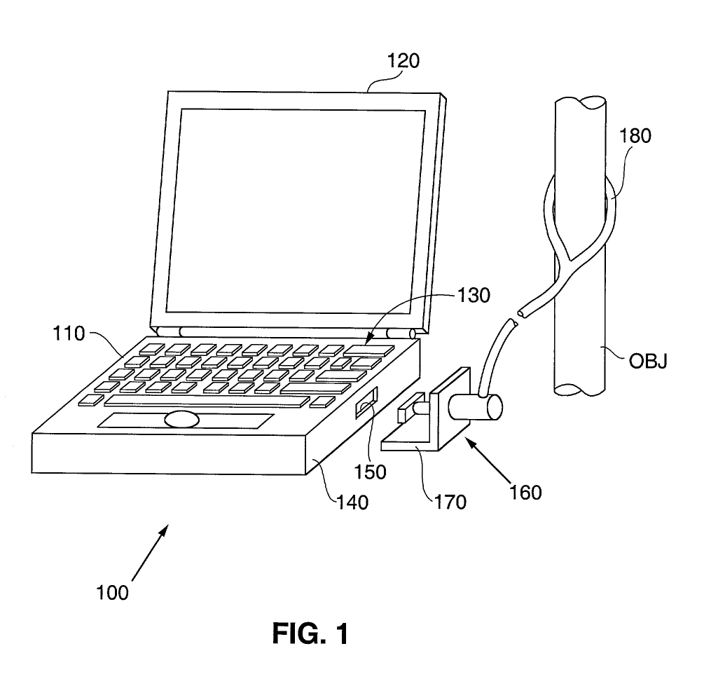

FIG. 1 is a perspective view of a locking system 100 according to a preferred embodiment of the present invention. Locking system 100 includes a portable electronic device 110 having a hinged member 120 that has an opened configuration (as shown) permitting access to the keys and other operational interface elements 130 of device 110, and a closed configuration (not shown) in which hinged member 120 overlies operational interface elements 130 to inhibit access. Device 110 has a side wall 140 that defines a security aperture 150. Preferably, security aperture conforms to Kensington security standard.

Locking system 100 includes an attachment system 160 having an attachment device 170 and a localizer 180. Attachment system 160 has two configuration modes: an engagement/disengagement mode in which attachment device 170 may engage and disengage security aperture 150, and a lock mode in which attachment device 170 is attached to device 110 via engagement of security aperture 150.

Localizer 180, coupled to attachment device 170, localizes attachment system 160 an object OBJ that is something other than device 110. When attachment system 160 is in the lock mode and localizer 180 is localized to object OBJ, device 110 is also localized to object OBJ. Attachment system 160 preferrably includes a lock (for example a tumbler, combination, or cable locking system) having a mechanism for maintaining attachment system 160 in the lock mode. As is explained later, attachment device 170 preferably includes two configurations: a first configuration for securing device 110 while hinged member 120 is in the opened configuration, and a second configuration for securing device 110 while hinged member 120 is in the closed configuration.

In operation, a user configures device 110 in either the opened or closed configuration and attachment system 160 (in the engagement configuration) engages security aperture 150. Attachment system 160 is transformed to the lock mode, and localizer 180 is localized to object OBJ to maintain device 110 within a predetermined distance of object OBJ. (Localizer 180 may be, depending upon application cable of attachment to object OBJ before or after connection to device 110.) Device 110 is secured in this fashion until attachment system 160 is transformed to a disengagement mode, freeing attachment system 160 from device 110. When attachment system 160 is engaged while hinged member 120 is in the closed configuration, attachment system 160 also maintains hinged member 120 in the closed configuration while concurrently localizing device 110 to object OBJ. In other applications, it may be preferable to secure device 110 in the closed configuration but it may not be necessary to localize device 110 to object OBJ. In this application, localizer 180 is not employed.

Device 110 is shown as a laptop computer. Device 110 can also be a personal digital assistant (PDA), electronic book reader, or other portable electronic device having a security aperture. Preferably, device 110 includes hinged member 120 that has a closed configuration. When attachment system 160 is in the locked configuration, attachment device 170 inhibits reconfiguration of hinged member to the opened configuration, inhibiting access and operation of operational interface elements 130.

However, in certain applications, device 110 may be equipped with a different type of access system. For example, a protective cover or access door that may be hinged or otherwise moveable (such as by sliding). Attachment system 160 may be adapted to work with these systems as well. In other applications, attachment device may be configured to selectively cover or otherwise inhibit access to a specific operational interface element 130. This is particularly simple when such specific operational interface element 130 is disposed on or near an edge or wall 140, or near security aperture 150. For example, an on/off switch may be covered by attachment device 170 when attachment system 160 is in the locked mode, disabling further operation or toggling of the on/off switch, for example.

Security aperture 150 is illustrated as being in a side wall 140 of device 110. Various applications provide for security aperture 150 to be in a back wall or even other placement. Attachment system 160 may be configured to operate with such other configurations. In the case when aperture 150 is in a back wall, and device 110 has hinged member 120 attached inward from a back edge, attachment device 170 may include an arm for overlying the top surface that is sufficiently long to interfere with transformation of hinged member 120 into the opened configuration.

Security aperture 150 is shown as a generally rectangular security slot having dimensions of about 7 millimeters by 3 millimeters. Other aperture configurations are possible and attachment system 160 may be adapted to engage such apertures.

Attachment system 160 includes an attachment device 170 having an ‘L-shaped’ member, but other configurations are also possible as will be further described below, for example. Attachment system 160 includes localizer 180 illustrated as a flexible cable. Other localization systems are possible, such as chain, monofilament, optic cable that initiates an alarm or other indication, or proximity detecting systems that issue an alarm or other indication if objects are separated beyond a preestablished distance.

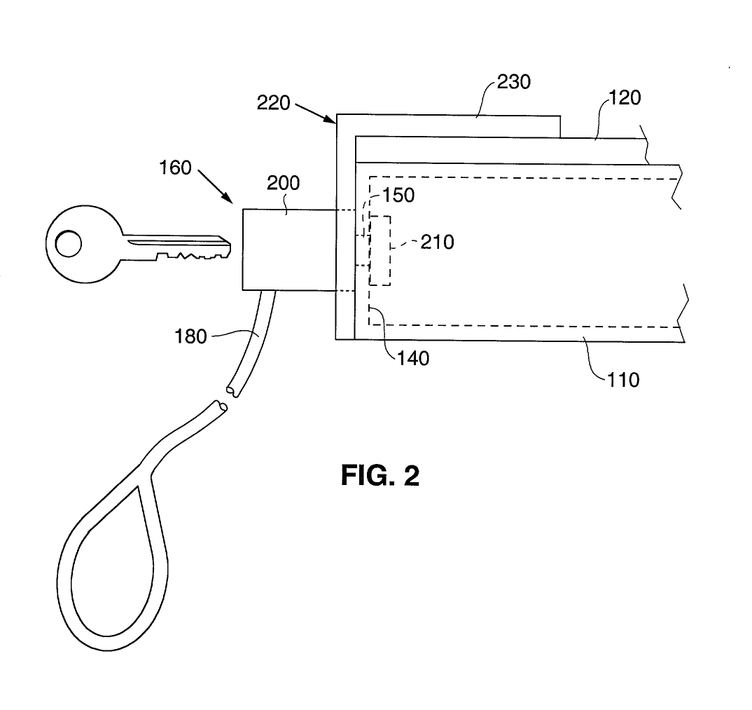

FIG. 2 is a perspective view of attachment system 160 according to a preferred embodiment of the present invention. Attachment system 160 includes a housing 200, a locking flange 210, and a locking member 220. Locking flange 210 extends from housing 200 and is sized so that it may be inserted into security aperture 150 in wall 140. In this preferred embodiment, locking flange 210 is a ‘T-shaped’ rotatable member that rotates about 90 degrees to engage/disengage and to lock. Locking member 220, also coupled to housing 200, cooperates with locking flange 210 to maintain locking flange 210 in the lock configuration relative to security aperture 150. Additionally, locking member 220 preferably includes an engagement arm 230 that extends past an edge of wall 140 when locking flange 210 is in a locking orientation relative to aperture 150.

When hinged member 120 is in the closed configuration, engagement arm 230 preferably extends beyond an edge of hinged member 120 to inhibit transformation of hinged member 120 to the open position, as shown. In an alternate use, such as for example when hinged member 120 is in the opened configuration, engagement arm 230 may be disposed along a bottomside of portable device 110.

Locking flange 210 may have other configurations than as described herein. Locking flange need not be ‘T-shaped’ but may have other configurations, including embodiments having multiple legs that pivot, slide or otherwise transform from a first mode that may be used to engage security aperture 150, to a second mode that is secured to security aperture 150, and then to a third mode that may be used to disengage from security aperture 150. Typically the third mode is virtually the same as the first mode, but it need not necessarily be the same. While locking flange 210 is shown without cooperating pins disposed on lateral sides of a rotating shaft, it may be desirable to use such cooperating pins depending upon a particular application. Locking member 220 may be generally configured to cooperate with locking flange 210 to achieve a similar result as previously achieved with the cooperating pins, but when the particular application does not permit such configuration, one or more pins may be used.

In some applications, locking flange may include a single leg, that rotates to engage the aperture. In other applications, locking flange may be ‘S-shaped’ and may rotate less than 90 degrees (in some cases substantially less than 90 degrees) to engage aperture 150. Locking flange 210 may sized substantially smaller than the overall dimensions of security aperture 150, but is sized to conform to preselected dimensions of a portion of security aperture sufficient to achieve the desired attaching reliability.

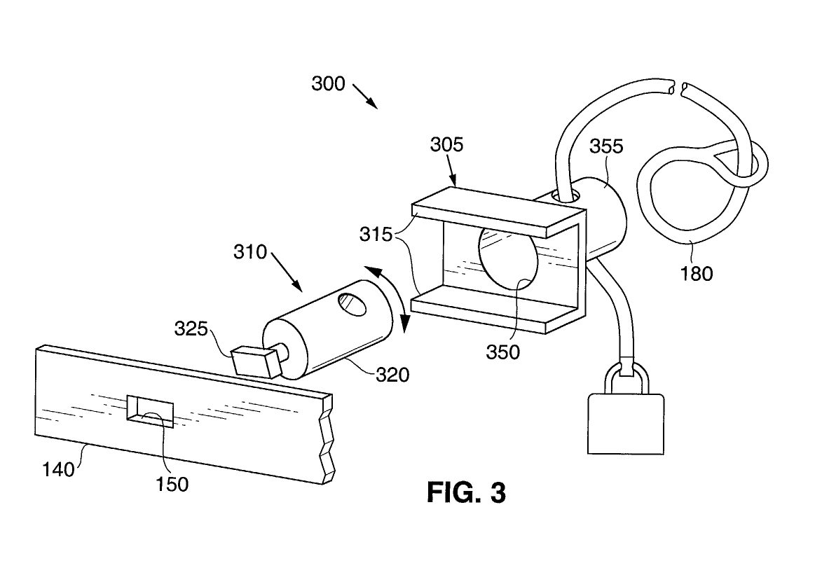

In other applications, such as described below with respect to FIG. 3, locking member 220 may include two engagement arms that extend beyond a topmost and a bottommost edge of wall 140, for example.

FIG. 3 is a perspective view of an alternate attachment system 300 according to an alternate preferred embodiment. Attachment system 300 includes a housing 305, a locking flange 310, and a locking member 315 integrated into housing 305. Locking flange 310 is a separate structure from housing 305 and includes a head portion 320 and flange portion 325. Head portion 320 has a circular cross-section and includes a first aperture passing through a diameter. Flange portion 325 includes a cross-member on a distal end of a shaft extending axially from head portion 320. The cross-member is sized to conform/complement preselected dimensions of security aperture 150 defined in wall 140. Wall 140 may be part of a wall of portable electronic device as shown in FIG. 1 and FIG. 2, or wall 140 may be a security adapter attached (such as for example by adhesive) to an object to be secured. The shaft is sized to permit flange portion 325 to extend past a thickness of wall 140 and Flange portion 325 need not necessarily have a ‘T-shaped’ configuration, as discussed above. Other configurations for locking flange 310 are possible, as long as the configuration is selectively engageable with, and disengageable from, security aperture 150.

Housing 305 includes a cavity 350 sized to receive head portion 320. Cavity 350 permits head portion 320 to pass through housing 350 and into a locking portion 355 of housing 305. Locking portion 355 has a circular cross-section and includes a second aperture passing through a diameter. When locking flange 310 is in the locked configuration, and head portion 320 is received by cavity 350, the first and second apertures are aligned. When localizer 180 is a cable, bar padlock or other similar structure, it may be passed through the aligned apertures and thereby maintain housing 305 coupled to locking flange 310, and thereby maintain flange portion 325 in the engaged position.

Housing 305 further includes one or more locking members 315 that extend orthogonal, when attachment system 300 is in the lock configuration, to a plane defined by wall 140, and extend past an edge of wall 140. Each locking member 315 of the preferred embodiment is spaced a sufficient distance from a center point of aperture 150 to engage the edge. When a configuration is used that includes two locking members 315, they are separated by at least the width of wall 140 proximate security aperture 150. As discussed above, a locking member 315 may be moved further from the centerpoint, at least a thickness of hinged member 120 shown in FIG. 2, to permit housing 305 to engage locking flange 310 when hinged member 120 is in the closed configuration. In this embodiment, locking members 315 are sufficiently long to inhibit transformation of hinged member 120 into the open configuration. Additionally, in this embodiment, it may be that one locking member 315 is spaced a different distance from the center point of aperture 150 than another locking member 315 to account for possible non-symmetries in aperture placement relative to edges of wall 140 and accounting for any additional thickness of hinged member 120. Alternatively, a locking member 315 may be constructed to have a variable or adaptable distance from the center point.

Thus, the invention has been described with reference to particular embodiments thereof. However, these embodiments are merely illustrative, not restrictive, of the invention, the scope of which is to be determined solely by the appended claims.

What is claimed is:

1. An apparatus for attaching to a first wall defining a security aperture, comprising:
a housing;
a locking flange, extending from said housing, having a first orientation relative to the security aperture for retention into the security aperture and a second orientation relative to the security aperture for removal from the security aperture, said locking flange transformable from said first orientation to said second orientation; and
a locking member, coupled to said housing and cooperative with said locking flange, for engaging an edge of the first wall outside of the security aperture and inhibiting transformation of said locking flange from said first orientation to said second orientation.

2. The apparatus of claim 1 wherein said first wall is orthogonal to a second wall and wherein said locking member comprises:
a plate that extends in a plane parallel to the first wall and is proximate the first wall when said locking flange is in said first orientation; and
an engagement arm, coupled to said plate and orthogonal to said plane, for extending past said edge when said locking flange is in said second orientation.

3. The apparatus of claim 1 further comprising:
a localizer, coupled to said housing, for associating said housing with an object other than the wall to limit movement of the wall beyond a predetermined distance from said object.

4. The apparatus of claim 1 wherein the first wall is part of a portable electronic device.

5. The apparatus of claim 4 wherein said portable electronic device includes a hinged member that overlies an operational surface of said portable electronic device.

6. The apparatus of claim 5 wherein said hinged member inhibits access to an operational control of said portable electronic device when said hinged member is in a first position and permits access to said operational control of said portable electronic device when said hinged member is in a second position.

7. The apparatus of claim 6 wherein the first wall is generally orthogonal to said hinged member, and said locking member extends proximate said hinged member when said hinged member is in said first position to inhibit transition of said hinged member from said first position to said second position.

8. The apparatus of claim 7 further comprising a lock, coupled to said locking flange, for inhibiting transformation of said locking flange from said first orientation to said second orientation when said lock is in a lock mode, said lock permitting transformation of said locking flange from said first orientation to said second orientation when said lock is in an unlock mode.

9. The apparatus of claim 1 wherein the security aperture is a rectangular security slot.

10. The apparatus of claim 9 wherein said locking member is a crossmember at a distal end of a rotatable member.

11. The apparatus of claim 9 wherein said locking member rotates when moving between said first orientation and said second orientation.

12. The apparatus of claim 11 wherein said locking member rotates no more than a quarter revolution.

13. The apparatus of claim 6 wherein said first wall is orthogonal to a second wall and wherein said locking member comprises:
a plate that extends in a plane parallel to the first wall and is proximate the first wall when said locking flange is in said first orientation; and
an engagement arm, coupled to said plate and orthogonal to said plane, having a first and a second mode, said first mode for extending past said edge when said locking flange is in said second orientation.

14. The apparatus of claim 6 wherein the wall is generally orthogonal to said hinged member, and said locking member extends proximate said hinged member when said hinged member is in said first position to inhibit transition of said hinged member from said first position to said second position.

15. A method for securing a hinged member of a portable electronic device in a closed position while securing an attachment member to a security aperture defined in a wall of the portable electronic device, comprising the steps of:
engaging the security aperture with a locking flange in a first orientation relative to the security aperture;
positioning a locking member into an engagement position, coupled to said locking flange, proximate to the hinged member in the closed position to inhibit transition of the hinged member to an opened position;
transforming said locking flange to a second orientation relative to the security aperture in which said locking member is retained within the security aperture to maintain said locking member proximate to the hinged member in said engagement position and to retain said locking flange in engagement with the security aperture until said locking flange is transformed into an orientation other than said first orientation relative to the security aperture; and
operating a lock, coupled to said locking flange, to a lock position while said locking flange is in said second orientation to inhibit transformation of said locking flange to an orientation that permits disengagement of said locking flange from the security aperture and repositioning of said locking member from said engagement position until said lock is operated to an unlock position.

16. The method of claim 9 further comprising the step of attaching a localizer, coupled to said locking flange, to an object other than to the portable electronic device, to inhibit movement of the portable electronic device beyond a predetermined distance from the object.
